(19) United States
(12) Patent Application Publication
(10) Pub. No.: US 2006/0119479 A1
(43) Pub. Date: Jun. 8, 2006

(54) Device to control and limit the use of an electrical apparatus with warning signals

(76) Inventor: Roberto Funto', Roma (IT)

Correspondence Address: LADAS & PARRY, 26 WEST 61ST STREET, NEW YORK, NY, 10023, US

(21) Appl. No.: 10/541,907

(22) PCT Filed: Jan. 21, 2004
(86) PCT No.: PCT/IT04/00010

§ 371 Date: Jul. 8, 2005

(30) Foreign Application Priority Data
Jan. 22, 2003 (IT) FR2003A000002

(51) Int. Cl. G08B 13/14; G08B 1/00; G08B 25/08

(52) U.S. Cl. 340/568.3; 340/309.16; 340/692

(57) ABSTRACT

This invention consists of a box protected by a key-block, inside which there is a socket where the plug of the electrical apparatus to control fits, connected to a programmed electronic circuit that controls the activation of a timer directing the connection/disconnection with the electric supply. The disconnection is anticipated by a touching, sound, bright, vocal and/or smelling signal, which can be preset by the user and allows to run any possible procedure of storage and/or shutdown. Once the connection is interrupted, the controlled apparatus cannot be turned on in any way, as it has no more the electric supply necessary to work.

### DESCRIPTION

1. Technical Field

The present invention relates to the technical sector of the production of accessories for the control of the activation/deactivation of electronic apparatus, in particular of television sets, so as to decide when said apparatus must be left on and when on the contrary it must be left off.

2. Background Art

Nowadays, we know instruments that permit to program the activation/deactivation of an electronic apparatus. In particular, many appliances can be programmed so as to be able to turn on/off at a prefixed time.

Nevertheless, said systems can be easily overcome modifying the programming system; for example, if we want to turn on an electrical/electronic apparatus after the system have turned it off, it's sufficient to program it again for the immediate start-up or manually push the relative button to make it work. Therefore, said systems cannot be used when we want to program the activation/deactivation of an electronic apparatus so that it cannot be turned on in that period of time when it has been programmed off. This kind of need particularly concerns TV sets, since parents are often out and they don't want their children to watch TV for a long period, therefore it's convenient to program the off action of the apparatus at a prefixed time and make it impossible to be turned on for a certain period of time.

Nowadays, there are not known systems capable of satisfying this need.

### DISCLOSURE OF INVENTION

This invention aims at permitting to control the use of electrical apparatus of any kind, therefore, by means of suitable electrical valves, also to control the flows of fluids such as gas, water, liquids in general, both for house or professional use. In other words, thanks to this invention it's possible to control that the apparatus is used only for the prefixed period of time. A blackout (or a failure of gas or other fluids) is anticipated by a signal that may be sound, bright, smelling, touching, telematic or other, and vocal, so that interested people are warned.

The device object of this invention is useful when we need to limit the use by others of any electrical apparatus or flows of fluids. The main example is the excessive use of television and videogames by children left alone at home. This device does not only tackle the problem by a technical point of view, but, following the advice of experts in youth psychology, it also allows youth to become more responsible thanks to the vocal message they have previously recorded with their parents or other responsible adults.

Briefly, this invention comprises a semi-fixed electric socket protected by a key-block, which permits to control the connection/disconnection of electrical apparatus or, by means of suitable electrical valve, the flow of fluids, and of a double circuit of timer that controls the activation/deactivation. This timer is anticipated by a touching, sound, bright, vocal and/or smelling signal, which can be preset by the user and allows to run any possible procedure of storage and/or shutdown required e.g. by connected computers or consoles.

Reduced to its essential structure, a device to control and limit the use of an electrical apparatus according to the present invention, includes: a box (O), closed by mechanical or electronic key, equipped with a hole (D) for the wire of the plug (C) of the apparatus to control (C1), inside which there is a socket (B) where said plug (C) fits, connected to a programmed electronic circuit (E) that controls a timer directing the connection with the electric supply and the activation of a sound or visual signal, before said connection is interrupted causing the electrical apparatus connected to the device stop.

Conveniently, the plug (C) of the apparatus to control fits into the socket (B) of the device, which in its turn is connected to the electric supply by means of the plug (A), so that the device is always connected to electric energy, while the apparatus to control (Cl) is connected to electric energy only when the timer decides, according to the preset programming.

This device comprises an electronic memory (F) where a message is recorded by the user or other person, so that before the apparatus turns off the pre-recorded message will be heard.

This technical feature is very important from an educational point of view, because the person or the youth, involved in this operation to limit the use of a certain electronic apparatus, can record his/her own message and listen to his/her voice before the apparatus turns off, being motivated to accept what it's happening.

Conveniently, this device includes inside said box, closed by mechanical or electronic key, the following components:
an electronic circuit (E) controlling the timer work;
an electronic memory (F) permitting the storage of the vocal message;
a microphone (H) for the recording of the vocal message;
a loudspeaker (O);
a pilot light (P);
a control panel of the timer and the recorder (G);
the REC and PLAY buttons (I);
a further button (L) with three positions (ON/OFF/BYPASS);
a display for the reading of the preset data (N);
a supply unit (R).

This device can be controlled even apart by means of a remote control (M). In this case, the box also includes a sensor (Q) for the remote control.

Conveniently, said components are included inside the box of the device in a further closed compartment (P1).

Conveniently, the box has a very tight opening (D), which only the wire of the apparatus connected to the device can pass through, so that the plug connected to it cannot be easily removed from the internal socket (B) that connects it to the control device.

Conveniently, this device can be activated or deactivated according to three different modes:
keeping it active and ready to carry out the preset instructions (ON);
keeping it blocked in such a position that does not permit the start and the use of the apparatus (OFF);
keeping it in “bypass” mode, i.e. in a position where it's possible to use the apparatus connected to it without any limitation (BYPASS).

When it is in the first mode (ON), the system allows the connection of the apparatus with the energy supply in the lapses of time programmed by the user.

In summary, this device constitutes a filter between the plug (C) of the apparatus to control (Cl) and the electric supply. As a matter of fact, the plug (C) is not directly connected to the supply socket, but on the contrary to the socket (B) inside the box of the device and only indirectly to the electric supply to which the plug (A) of the same device is connected. This device is therefore a filter between the plug of the apparatus to control and the socket of the electric supply, so that energy supply always arrives to the device, but reaches the apparatus to control only in the preset period of time, so permitting to turn the apparatus on/off. When the connection with the electric supply is active, the user can choose at his/her discretion to keep the apparatus on/off, but when the connection is deactivated the apparatus must be necessarily off.

We are now going to describe one of the possible manufacturing systems of this invention.

The device is essentially made of a box with a cover that can be opened only by the relative electronic or mechanical key.

From said box the supply wire (A) comes out to be connected to a standard electric socket with 220 volts. Opening this box, we find the internal socket (B) where the plug (C) of the apparatus to control (C1) fits. The wire of said plug (C) comes out from the other side of the box through a tight opening (D) making it impossible to be disconnected from the outside. Inside the box, in a suitable closed compartment, we find the electronic, electromechanical or mechanical circuit of the timer with the chip containing the sequence of instructions to fulfil (E), and the chip allowing the storage of the vocal message (F). These components can be directed by means of a control panel of the timer and the recorder (G), which permits to prefix the period of time when the internal socket must be supplied as well as the time to anticipate the deactivation, and the microphone (H) for the recording of the vocal message, controlled by two relative buttons REC and PLAY (I). A further button (L) with three positions (ON/OFF/BYPASS), which can be directed even by an infrared or ultrasound remote control, permits to control the status of the device according to the following modes:

ON—the device is active and carries out the preset instructions;

OFF—the device is blocked and does not permit the start and use of the apparatus;

BYPASS—the device is in “bypass” mode, which means that it's possible to use the apparatus without any limitation.

Out of the box, we find the liquid crystal display (N), or other kind of alphanumerical system to read the preset data, which indicates the status (ON/OFF/BYPASS) of the device and the preset lapse of time, the loudspeaker (O) emitting the sound signal and/or the pre-recorded message, the pilot light (P) and the possible sensor for the remote control (Q).

A plug battery (R), e.g. with 9 volts, ensures the energy supply to the watch, also in the case of a blackout, for enough time. Therefore, within this period the device does not lose the programming, even if it cannot normally operate.

This device is small and its size can be further reduced as the miniaturization techniques of the electronic components are developing.

As for the programming, the device allows to control, acting on the electric supply, any apparatus connected to it. By means of suitable relays or electric valves, it also permits to control the flow of fluids such as gas, water, liquids or other, so permitting to improve the security standards, e.g. interrupting the flow of said fluids during night. The pre-recorded vocal or sound message can be circulated by means of a system of loudspeakers, so warning all the people in a certain building of the next interruption of the flow of a particular fluid. Also at home, it's possible to preset the security suspension of the flow of gas during night and/or day hours when individuals are out. In the case we need to temporarily reactivate the suspended flow, the suitable remote control (M) or the button with three positions (L) however permits to restart the flow and easily come back to its suspension when the extraordinary utilization has finished. The device object of the present invention can be used in many different cases. First of all, it tackles the problem of the youth left alone at the TV or the game console for too much time, but obviously it may be use in several different situations where it's necessary to limit, in the range of the 24 hours, the use of certain appliances.

The approach to the above-mentioned problem is one of the most innovative aspects of this device. According to the advice of experts in this field, the use of the present device offers a first phase of decision between parents and children about the possible time to use the apparatus to control. In the second phase, when the device implements its technical task, the vocal message pre-recorded by the minor recalls the agreement taken with his/her parents. In this way, besides the practical effect to avoid the abuse of the apparatus at issue, which in the most serious cases might cause psychophysical damages, we get an education effect on the youth for the honouring of the undertaken commitment.

Output and operating costs of this invention are extremely reduced, above all for the basic models.

This device is completely versatile, as it can be connected to any kind of apparatus, e.g. office terminal networks, computers, machine tools or, at home, TV sets, game consoles, electrical appliances, mechanisms to open the doors.

This system uses all standard components, easy to find on the market, and can be realized in several manufacturing ways, but still remaining within the principal characteristics of this idea. It can be realized in versions assembling control panels or electronic racks, in wall or sunk structure.

The system has been realized in order to be used in any environment, as it may be hold in other supports and may be connected to the main apparatus or to the one to control, by one or more control systems, either manually or telematically, by wire, optical fibre, air or other.

### BRIEF DESCRIPTION OF DRAWINGS

FIG. 1 shows the device including: a supply wire (A), a socket (B), the timer circuit with the chip (E), the chip permitting the storage of the vocal message (F), a control panel of the timer and the recorder (G), the microphone for the recording of the vocal message (H), the REC and PLAY buttons (I), a further button (L) with three positions (ON/OFF/BYPASS), a display for the reading of the preset data (N), the loudspeaker (O), the pilot light (P), a supply unit (R). This device can be controlled even apart by means of a remote control (M), in this case, the box also includes a sensor (Q) for the remote control. The device is then connected to the electronic apparatus to control (C1), by means of the plug (C) passing through the opening (D).

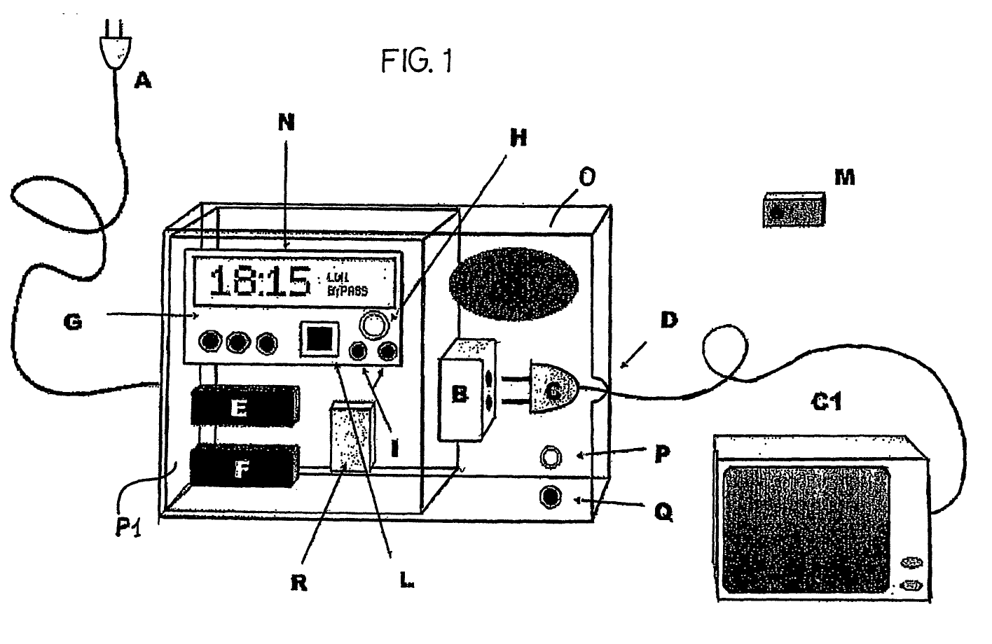

1) Device to control and limit the use of an electrical apparatus, characterised in that it includes: a box, closed by mechanical or electronic key, equipped with a hole for the wire of the plug of the apparatus to control, inside which there is a socket where said plug fits, connected to a programmed electronic circuit that controls a timer directing the connection with the electric supply and the activation of a sound or visual signal, before said connection is interrupted causing the electrical apparatus connected to the device stop.

2) Device as claimed in claim 1, characterized in that the plug of the apparatus to control fits into the socket of the device, which in its turn is connected to the electric supply by means of a second plug, so that the device is always connected to electric energy, while the apparatus to control is connected to electric energy only when the timer decides, according to the preset programming.

3) Device as claimed in claim 1, characterized in that it comprises an electronic memory where a message is recorded, which circulates before the apparatus turns off.

4) Device as claimed in claim 1, characterized in that it includes inside said box the following components:
an electronic circuit (E) controlling the timer work;
an electronic memory (F) permitting the storage of the vocal message;
a microphone (H) for the recording of the vocal message;
a loudspeaker (O);
a pilot light (P);
a control panel of the timer and the recorder (G);
the REC and PLAY buttons (I);
a further button (L) with three positions (ON/OFF/BYPASS);
a display for the reading of the preset data (N);
a supply unit (R).

5) Device as claimed in claim 4, characterized in that it can be controlled even apart by means of a remote control (M), for which it includes a sensor (Q).

6) Device as claimed in claim 1, characterized in that said box has a very tight opening (D), which only the wire of the apparatus connected to the device can pass through, so that the plug connected to it cannot be easily removed from the internal socket (B) that connects it to the control device.

7) Device as claimed in claim 1, characterized in that it can be activated or deactivated according to three different modes:
keeping it active and ready to carry out the preset instructions (ON);
keeping it blocked in such a position that does not permit the start and the use of the apparatus (OFF);
keeping it in “bypass” mode, i.e. in a position where it's possible to use the apparatus connected to it without any limitation (BYPASS).
